(19) United States
(12) Patent Application Publication
(10) Pub. No.: US 2016/0333260 A1
(43) Pub. Date: Nov. 17, 2016

(54) COMPOSITIONS AND METHODS FOR RE-FRACTURING WELLS

(71) Applicant: Preferred Technology, LLC, Radnor, PA (US)

(72) Inventors: Kerry Drake, Radnor, PA (US); Robert McDaniel, Radnor, PA (US); Amr M. Radwan, Radnor, PA (US); Andrew Nordquist, Radnor, PA (US)

(21) Appl. No.: 15/153,258

(22) Filed: May 12, 2016

Related U.S. Application Data
(60) Provisional application No. 62/160,796, filed on May 13, 2015.

(51) Int. Cl. C09K 8/80; E21B 43/267; E21B 43/26; C09K 8/68

(52) U.S. Cl. CPC C09K 8/805; C09K 8/68; E21B 43/267; E21B 43/26

(57) ABSTRACT

Compositions and methods for re-fracturing wells are provided.

### CROSS-REFERENCE TO RELATED APPLICATIONS

This application claims priority to U.S. Provisional Application No. 62/160,796, filed May 13, 2015, which is hereby incorporated by reference in its entirety.

### FIELD

Embodiments disclosed herein relate to, for example, compositions and methods for refracturing wells.

### BACKGROUND

Hydraulic fracturing is a technique that is commonly used to enhance oil and gas production. In this process, a large amount of fluid is pumped into a drilled wellbore with targeted areas of the rock are exposed to the fluid. The high pressure fluid induces a crack or fracture in the rock. All hydraulically-fractured wells suffer from a major reduction in created fracture half-lengths leading to losing a massive formation covering area. Re-fracturing under-stimulated fractures aims to improve the production of the well. Previous methods have not been satisfactory in achieving these goals. Thus, there, still exists a need for compositions and methods that can be used for re-fracturing wells that have already been fractured. The embodiments disclosed herein satisfy these needs as well as others disclosed herein.

### BRIEF DESCRIPTION OF THE DRAWINGS

FIG. 1 illustrates the re-fracturing a multi-stage completed well with a light weight proppant.

FIG. 2 illustrates re-fracturing a vertical well with a light weight proppant.

### DETAILED DESCRIPTION

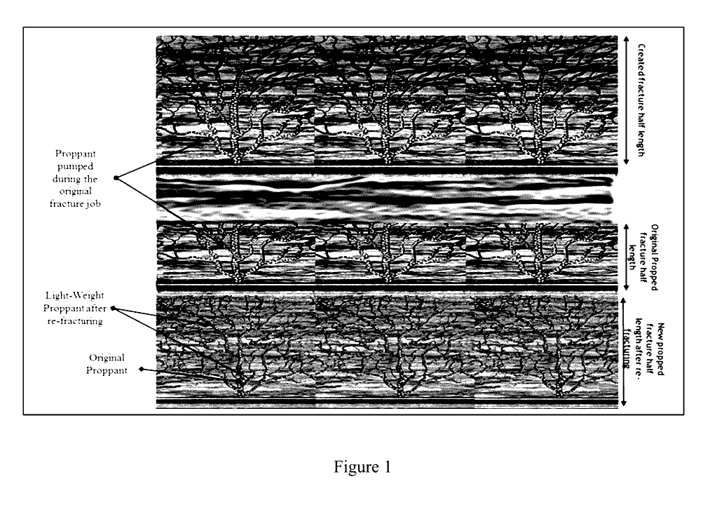

Embodiments provided herein provide methods and compositions for well re-stimulation method by re-fracturing, which can also be referred to as “re-fracturing.” The compositions can be performed with, for example, light weight proppants, such as but not limiting to, a class of proppants that is sometimes referred to as self-suspending proppants (“SSP”). Without being bound to any particular theory, well re-fracturing using the embodiments and compositions disclosed herein can bypass the propped fracture volume problem that exists in fractured wells (due to its floating/buoyancy capability) to prop the deep unpropped volume of the formation and/or prop the upper unpropped side of the fracture volume (FIG. 1). The embodiments disclosed herein, can also improve the proppant distribution over the initially propped fracture surface area, leading to an even stress on proppants, which can increase the long term sustainability of effective fracture conductivity. One of the advantages, but not the only advantage, using light-weight proppants in re-fracturing is that it will increase the estimated ultimate recovery (EUR) of the well, thus making the well more valuable and more cost-efficient.

In some embodiments, methods are provided to extend the effective fracture volume in low and ultra-low permeability formations. In some embodiments, the methods comprise injecting into an existing fractured subterranean formation one or more light weight proppants.

In some embodiments, the method comprises increasing the conductivity of the proppants in the previously stimulated (opened) fractures. The embodiments can be used to increase the effective fracture volume and can increase well's estimated ultimate recovery (EUR), such as in in nano-darcy formations (i.e. shale formations).

Re-fracturing using light-weight proppants can be used with any re-fracturing system by simply replacing a conventional proppant with a light-weight proppant. In some embodiments, the methods uses light-weight proppants for the entire re-fracture job or a portion of the proppant volume. Thus, in some embodiments, the light-weight proppant is at least 10, 20, 30, 40, 50, 60, 70, 80, 90, 95, or 99% of the total proppant volume.

The light weight proppants can be injected using any fracture fluid. In some embodiments, the light weight proppant is added using slickwater. In some embodiments, the slickwater is used in conjunction with the light weight proppants for the under-stimulated fractures, can improve the ability of slickwater to transfer the proppant and increase the propped fracture volume. Slickwater is just one example of the type of fracture fluid. However, in some embodiments, the light weight proppants can be used in re-fracturing operations with any fluid system used by one of skill in the art.

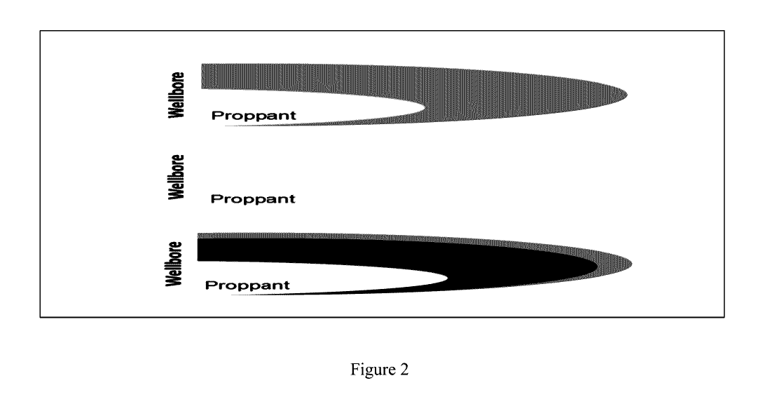

Another advantage of the present composition and methods is that in a vertical well, the methods can create an increase (more than the conventional proppant) in both fracture height and half-length in order to create uniform vertical and horizontal proppant distribution. (FIG. 2). This can lead to increased well productivity.

A light weight proppant is any proppant that can be used in the methods and processes described herein. Examples include, but are not limited to, particulates and proppants coated with the coatings described herein. Other examples include those that are described in WO 2013033391, WO2015047908, U.S. Pat. No. 7,723,274, U.S. Pat. No. 8,236,738, U.S. Pat. No. 8,105,986, US 20130206408, U.S. Pat. No. 8,006,759, WO 2011014410, and US 20060016598 each of which is hereby incorporated by reference in its entirety. In some embodiments, the light weight proppant has a density less than about 2, 1.5, or 1. In some embodiments, the proppant comprises materials with a specific gravity/density that is less than about 0.5, 1, or 1.5. Non-limiting examples of such light weight proppants include hydrogel swellage coated proppants, ultra-light weight ceramic proppants, hydrophobic coated proppants treated with and without nitrogen (including, but not limited to, those described herein), walnut shells, glass spheres (e.g. hollow), porous ceramics, plastics, thermoplastic alloy (“TPA”), and the like, and any combination thereof. Other examples of proppants and their densities can be found in “In Search of Bigger, Stronger, and Lighter Ways to Open Paths for Oil Production,” Stephen Rassenfoss, JPT Emerging Technology, April 2013, which is hereby incorporated by reference in its entirety.

Other non-limiting examples of light weight proppants that can be used are for example, a particulate core coated with a compatibilizing agent and a hydrophobic polymer or a aoated particulate, wherein the coating is a mixture of 1) an alkoxylate or an alkoxylated alcohol, 2) an acrylic polymer, and 3) an amorphous polyalphaolefin. Examples of such coated particulates (proppants) are described in U.S. Provisional Application No. 62/160,786, filed May 13, 2015, 62/197,916, filed Jul. 28, 2015, 62/220,373, filed Sep. 18, 2015, 62/237,182, filed Oct. 5, 2015, and 62/310,039, filed Mar. 18, 2016, U.S. patent application Ser. No. 15/073,840, filed Mar. 18, 2016, and PCT Application No. PCT/US16/32104, filed May 12, 2016, each of which is hereby incorporated by reference in its entirety. Thus, the methods can use particulates that are hydrophobic polymer coated particulates (proppants). The coated particulates can provide a hydrophobic surface that can enhance proppant transport into a fracture during the process of hydraulic fracturing. This can enhance the productivity of the well. Additional coatings and coated particulates are also described herein. The coatings can be applied through the use of one or more treatment agents. The treatment agents can be a single agent or a combination of agents. Non-limiting examples of such singular agents or combinations are provided herein.

“Treatment agents” are described herein. They can be liquid treatment agents. Examples, include, but are not limited to an aqueous solution, dispersion, or emulsion. The treatment agent can also be a combination of solids that are applied to the particulate core that makes up the proppant. The treatment agents can be heated or not heated before, after, or during the application processes described herein. In some embodiments, the treatment agent is not heated before, after, or during the application process. In some embodiments, the treatment agent is heated on the particulate downhole or in the well. The coatings can also be supplemented with other elements and coatings as described herein. Any coating described herein can be combined with one another.

The coated particulates provided herein can be used in any of the methods. In some embodiments, the coated particulate comprises a particulate core with a compatibilizing agent and a hydrophobic polymer coating the particulate core. In some embodiments, a portion of the hydrophobic polymer is exposed to provide an exposed hydrophobic surface of the coated particulate. The compatibilizing agent can be any agent that facilitates the binding of the hydrophobic polymer to the particulate core. For example, when hydrophobic polymers are mixed with particulate cores without a compatibilizing agent the hydrophobic polymer can flake off and leave the particulate core without a coating or a sufficient coating. Thus, the compatibilizing agent can enhance the hydrophobic coating by enabling the hydrophobic polymer to more readily bind to the particulate core. Non-limiting examples of compatibilizing agents are provided herein, however, any agent that can facilitate the binding of the hydrophobic polymer to the particulate core can be used. Examples of hydrophobic polymers are also provided herein, but others can be also be used. Without wishing to be bound by any particular theory, the hydrophobic coating provides the following functionality. Hydrophobic polymers containing groups that have low surface energy that imparts an enhanced chemical affinity for non-polar nitrogen molecules, and thus supports the formation of bubbles or a plastron (trapped film or air) to form on the surface of the polymer. The bubbles or plastron will generate increased buoyancy of the particles and thus enhance the transport in a flowing fluid media. Polymers with functional groups or side chains that contain aliphatic methyl, ethyl, propyl, butyl and higher alkyl homologs can be used to generate this type of effect. Polymers with fluoro groups also impart low surface energies and oleophobic as well as hydrophobic character. Examples of these include trifluoromethyl, methyldifluoro (vinilidyine fluoride copolymers, hexafluoropropyl containing polymers, side chains that contain short chains of fluoropolymers and the like. Therefore, these polymers can also be used in some embodiments. Commercially available fluorosilicones can also be used.

In some embodiments, the compatibilizing agent binds the hydrophobic polymer to the particulate. In some embodiments, the compatibilizing agent encapsulates the particulate core and a first surface of the hydrophobic polymer binds to the compatibilizing agent and a second surface of the hydrophobic polymer is exposed to provide the exposed hydrophobic surface of the coated particulate.

In some embodiments, the coated particulate has enhanced particulate transport as compared to a particulate without the exposed hydrophobic surface. The enhanced transport can be in the presence of a gas, such as but not limited to nitrogen gas, carbon dioxide, air, nonpolar gases, or any combination thereof.

Examples of compatibilizing agents include, but are not limited to, silanes, surfactants, alkoxylated alcohol, acrylate polymer, or combinations thereof. The surfactant is not being used as a frother, or ingredient which is designed to be released into the fluid media to enhance bubble formation, but rather as a coupling agent that enables the hydrophobic polymer to better bind to the particulate core. In some embodiments, the silane is an alkoxysilane. Examples of alkoxysilanes include, but are not limited to, methoxmethylsilane, ethoxysilane, butoxysilane, or octoxysilane including, but not limited to, Dynasylan® or Geniosil®.

An example of a surfactant that can be used as a compatibilizing agents includes, but is not limited to a hydroxysultaine. A non-limiting example of a hydroxysultaine is cocamidopropyl hydroxysultaine.

Non-limiting examples of alkoxylated alcohols are, but not limited to, Brij™ or Ecosurf™ products.

Various hydrophobic polymers are described herein that can be used in conjunction with the compatibilizing agent. In some embodiments, the coated particulate with a coating comprising a compatibilizing agents and a hydrophobic polymer comprises a hydrophobic polymer that is an amorphous polyalphaolefin. In some embodiments, the hydrophobic polymer is a non-siloxane hydrophobic polymer.

In some embodiments, the hydrophobic polymer is a copolymer or a graft polymer. In some embodiments, the copolymer and/or the graft polymer comprises both hydrophilic groups and hydrophobic groups, provided that the majority of groups are hydrophobic groups. In some embodiments, the hydrophilic groups bond with the particulate surface through van der Waals forces. In some embodiments, the hydrophilic groups are an amine, amide, ester, urethane, or a combination thereof. Examples of such polymers include, but are not limited to, copolymers of olefins and acrylic acids, olefins and acrylates, olefins and maleic anhydrides, and the like.

In some embodiments, the hydrophobic polymer is a low molecular weight polymer below or slightly above the critical entanglement chain length (which varies by polymer). For example, critical molecular weights (Mc or Me) can range from 3,000 to 350,000 depending on the polymer (See Mark “Physical Properties of Polymers Handbook, Chapter 25 Tables 25.2-25.6. In some embodiments, the low molecular weight polymer is a hydrophobic olefin polymer. In some embodiments, the hydrophobic polymer has a crosslinkable moiety. In some embodiments, the hydrophobic polymer has an irregular backbone or pendant groups that disrupt crystallization.

In some embodiments, the coated particulates and proppants described herein are substantially free, or free, of an agent that is acting as a frother. An agent is acting as a frother if the agent increases the surface tension (bubble strength) of air bubbles in solution. However, the agent should be added with the intent of acting as a frother. Thus, although a surfactant may in some instances act as a frother, it can also act independently as a compatibilizing agent for attachment of the hydrophobic polymer to the particles. A small amount of surfactant may also be added to initially reduce the possibility of formation of bubbles or plastrons on particles when first exposed to water, but prior to introduction into a blender for hydraulic fracturing slurry preparation, so as to avoid snaking and possible cavitation and blender or pump damage. In some embodiments, the frother is not an alcohol.

In some embodiments, the % wt of the hydrophobic polymer is less than or equal to 0.5% wt of the particulate. Other % wt are provided herein and the hydrophobic polymer can also be in those proportions as well.

In some embodiments, the coated particulates (proppant solids) are substantially free or completely free of hydrogels. For the avoidance of doubt, embodiments provided herein can provide with coated proppants or particulates that include hydrogels or are free of hydrogels regardless of where they are described herein.

Various processes are described herein for adding coatings. Such processes can be used or modified to add the coatings and materials described herein. For example, the sprayers described below can be used to apply the coating comprising the compatibilizing agent and the hydrophobic polymer. The coatings can also be applied according to other resin coating methods, such as those described in U.S. Provisional Application No. 62/072,479 filed Oct. 30, 2014 and U.S. Provisional Application No. 62/134,058, filed Mar. 17, 2015, each of which are hereby incorporated by reference in its entirety. The coatings can also be using the devices and methods described in U.S. application Ser. No. 14/528,070, filed Oct. 30, 2014, which claims priority to U.S. Provisional Application No. 61/898,328, filed Oct. 31, 2013, each of which is hereby incorporated by reference in its entirety. The particles can also be prepared according to U.S. Provisional Application No. 62/160,786, entitled, Hydrophobic Coating of Particulates for Enhanced Well Productivity, filed May 13, 2015, which is incorporated by reference in its entirety.

In some embodiments, process for preparing coated particulates are provided. In some embodiments, the coated particulate comprises a particulate core coated with a compatibilizing agent and a hydrophobic polymer. In some embodiments, the process comprises contacting the particulate core with the compatibilizing agent and the hydrophobic polymer under conditions sufficient to coat the particulate core to produce the coated particulate. The compatibilizing agent and the hydrophobic polymer can be contacted (mixed, baked, sprayed, adsorbed onto, and the like) simultaneously or sequentially. In some embodiments, the core is contacted initially with the compatibilizing agent followed by the hydrophobic polymer. In some embodiments, the core is contacted initially with the hydrophobic polymer followed by the compatibilizing agent. In some embodiments, the core is contacted with the compatibilizing agent for a period of time by itself and then together with the hydrophobic polymer.

As described herein, particulates (proppants) can be contacted with various treatment agents. In some embodiments, the treatment agent comprises the compatibilizing agent. In some embodiments, the treatment agent comprises the hydrophobic polymer. In some embodiments, the treatment agent comprises the compatibilizing agent and the hydrophobic polymer. The treatment agents can be applied sequentially or simultaneously. For example, in some embodiments, the particulate core is contacted with a first treatment agent comprising a compatibilizing agent and a second treatment agent comprising a hydrophobic polymer. In another non-limiting example, the particulate core is contacted with the first treatment agent and the second treatment agent simultaneously. In some embodiments, the particulate core is contacted with the first treatment agent and the second treatment agent sequentially.

The processes provided herein, therefore, provide a process that comprises coating a particulate core with a compatibilizing agent to produce a particulate coated with the compatibilizing agent; and coating the particulate coated with the compatibilizing agent with a hydrophobic polymer. In some embodiments, the compatibilizing agent encapsulates the particulate core and a first surface of the hydrophobic polymer binds to the compatibilizing agent and a second surface of the hydrophobic polymer is exposed to provide an exposed hydrophobic surface of the coated particulate.

The processes can be used to produce a coated particulate that has enhanced particulate transport as compared to a particulate without the exposed hydrophobic surface.

The compatibilizing agent and hydrophobic polymers can be any agent that is suitable, such as, but not limited to, those described herein.

In some embodiments of the process provided herein, the compatibilizing agent is contacted with the particulate core at a temperature of about 20-25 C. In some embodiments, the hydrophobic polymer is contacted with the particulate core at a temperature of about 20-25 C. In some embodiments, the compatibilizing agent is contacted with the particulate core at a temperature of at least 100 C. In some embodiments, the hydrophobic polymer is contacted with the particulate core at a temperature of at least 100 C.

In some embodiments, the method for the producing the coated particulates can be implemented without the use of solvents. Accordingly, the mixture obtained in the formulation process is solvent-free, or is essentially solvent-free. The mixture is essentially solvent-free, if it contains less than 20 wt %, less than 10 wt %, less than 5 wt %, less than 3 wt %, or less than 1 wt % of solvent, relative to the total mass of components of the mixture.

In some embodiments, during the formulation process, the proppant is heated to an elevated temperature and then contacted with the coating components. In some embodiments, the proppant is heated to a temperature from about 50° C. to about 150° C. to accelerate the coating of the particulate.

In addition to the systems described herein, a mixer can be used for the coating process and is not particularly restricted and can be selected from among the mixers known in the specific field. For example, a pug mill mixer or an agitation mixer can be used. For example, a drum mixer, a plate-type mixer, a tubular mixer, a trough mixer or a conical mixer can be used. In some embodiments, the mixing is performed in a rotating drum although a continuous mixer or a worm gear can also be used for a period of time within the range of 1-6 minutes, or a period of 2-4 minutes during which the coating components are combined and simultaneously reacted on the proppant solids within the mixer while the proppant solids are in motion.

Mixing can also be carried out on a continuous or discontinuous basis. In suitable mixers it is possible, for example, to add the agents continuously to the heated proppants. For example, the compatibility agent and/or the hydrophobic polymer can be mixed with the particulates in a continuous mixer (such as a worm gear) in one or more steps to make one or more layers of the coating.

The temperature can be modified or restricted as described herein. Additionally, in some embodiments, the coating step is performed at a temperature of from about 10° C. to about 200° C., from about 10° C. to about 150° C., from about 20° C. to about 200° C., from about 20° C. to about 150° C., from about 30° C. to about 200° C., from about 30° C. to about 150° C., from about 40° C. to about 200° C., from about 40° C. to about 150° C., from about 50° C. to about 200° C., from about 50° C. to about 150° C., from about 60° C. to about 200° C., from about 60° C. to about 150° C., from about 70° C. to about 200° C., from about 70° C. to about 150° C., from about 80° C. to about 200° C., from about 80° C. to about 150° C., from about 90° C. to about 200° C., from about 90° C. to about 150° C., from about 1000° C. to about 200° C., or from about 100° C. to about 150° C. In some embodiments, it is the particulate that is at the temperature. In some embodiments, the reaction (contacting/mixing) is at the temperature.

In some embodiments, the agents may be applied in more than one layer to produce the light weight proppants. In some embodiments, the coating process is repeated as necessary (e.g. 1-5 times, 2-4 times or 2-3 times) to obtain the desired coating thickness. In some embodiments, the thickness of the coating of the particulate can be adjusted and used as either a relatively narrow range of coated particulate size or blended with proppants of other sizes, such as those with more or less numbers of coating layers of the compositions described herein, so as to form a coated particulate blend have more than one range of size distribution. In some embodiments, a range for coated particulate is about 20-70 mesh.

In some embodiments, the coated proppants (e.g. light weight proppants) can be baked or heated for a period of time. In some embodiments, baking or heating step is performed like a baking step at a temperature from about 100°-200° C. for a time of about 0.5-12 hours or at a temperature from about 125°−175° C. for 0.25-2 hours. In some embodiments, the coated particulate is cured for a time and under conditions sufficient to produce a coated particulate that exhibits a loss of coating of less than 25 wt %, less than 15 wt %, or less than 5 wt % when tested according to ISO 13503-5:2006(E).

As described herein, agents can be applied to the particulates in a short amount of time. The same can time limits can be applied to the application of the compatibilizing agents and/or the hydrophobic polymers to the particulates. For example, in some embodiments, the compatibilizing agent is contacted with the particulates for about less than five, four, three, or two seconds. In some embodiments, the hydrophobic polymer is contacted with the particulates for about less than five, four, three, or two seconds.

In some embodiments, the particulates are contacted more than once with the hydrophobic polymer and/or compatibilizing agent.

As described herein for other process, in some embodiments, the contacting comprises spraying said compatibilizing agent and/or hydrophobic agent onto said particulate core while said particulate core is in free fall, guided free fall, or during pneumatic transport. In some embodiments, the particulate is contacted with the compatibilizing agent and/or the hydrophobic polymer for the time it takes said particulate to fall a distance of four feet by gravity.

In some embodiments, the contacting comprises spraying said particulates substantially simultaneously from more than one direction. They can be sprayed with one or more treatment agents. The treatment agents can contain the same components or different components. For example, in some embodiments, each of the treatment agents comprises both the compatibilizing agent and the hydrophobic polymer. However, in some embodiments, one agent comprises the compatibilizing agent and another agent comprises the hydrophobic polymer. Thus, just as in other embodiments, the components can be applied to the particulates separately in different or the same compositions (e.g. solutions).

Devices and systems are described in references cited herein for applying the various compositions herein to particulates, such as, but not limited to sand. The compatibilizing agent and the hydrophobic polymer can be utilized in the same devices and systems. Therefore, in some embodiments, the compatibilizing agent and/or the hydrophobic polymer is contacted with the particulates immediately before, concurrently with, or immediately after passing the particulates through a static mixer. The process can also comprise applying the compatibilizing agent with a first spray assembly onto the particulate core for less than five seconds; passing the treated particulate core through a static mixer; and applying the hydrophobic polymer with a second spray assembly onto the particulates for less than five seconds. In some embodiments, the first spray assembly applies a composition comprising both the compatibilizing agent and the hydrophobic polymer. In some embodiments, the second spray assembly applies a composition comprising both the compatibilizing agent and the hydrophobic polymer. In some embodiments, first spray assembly applies both the compatibilizing agent and the hydrophobic polymer while the second spray assembly only applies the hydrophobic polymer. In some embodiments, first spray assembly applies both the compatibilizing agent and the hydrophobic polymer while the second spray assembly only applies the compatibilizing agent.

In some embodiments, the process comprises coating the particulate with a dust reduction coating. Various dust reduction coatings are described herein and can be used. Other coatings and agents can be added to the particulate simultaneously or sequentially in addition to the coating comprising the compatibilizing agent and the hydrophobic polymer. Examples of dust reduction coatings, include, but not limited to, those described in U.S. application Ser. No. 14/528,070, which is hereby incorporated by reference in its entirety.

Embodiments described herein and below can be used alone or combination with the embodiments described herein and above. Where appropriate the coatings and compositions can be substituted with one another as would be readily apparent to one of skill in the art. Therefore, although some embodiments may refer to a dust reduction coating, the coating can be replaced or supplemented with a coating comprising the compatibilizing agent and/or the hydrophobic polymer.

In some embodiments described herein, embodiments use a treatment agent (e.g. liquid treatment agent) that is applied at extremely low levels, e.g., at levels that avoid making the particulates perceptibly wet such as observed by, e.g., drips, puddles, a visible wet sheen or a wet “feel” upon handling the treated solids. In some embodiments, some treatments might require mild drying after contact with the sprayed treating agent in order to avoid “perceptibly wet” particles, especially those prepared using non-aqueous based solvent carriers. These treatment agents can include the treatment agents described herein comprising a compatibilizing agent and/or a hydrophobic polymer.

In some embodiments, the treatment agent level is also fast and sufficiently low in applied volumes to avoid the formation of firmly agglomerated masses of treated solids that are not readily transported by conventional dry proppant solids handling equipment, e.g., gravity-fed conveying systems, pneumatic transport, and the like. In other words, the proppant solids that are treated according to the presently disclosed methods continue to act and be subject to handling by conventional proppant solids handling equipment and systems. In some embodiments, the treatment agent is applied or contacted with the solids for less than or equal to 20, 19, 18, 17, 16, 15, 14, 13, 12, 11, 10, 9, 8, 7, 6, 5, 4, 3, 2, or 1 seconds. As used herein, the phrase “less than” when used in reference to a certain of period of time does not include zero unless explicitly stated. In some embodiments, the treatment agent is contacted with the solids for about 0.1 to about 5 seconds, about 0.1 to about 10 seconds, about 0.1 to about 15 seconds, or about 0.1 to about 20 seconds. In some embodiments, the treatment agent is contacted with the solids for about 1 to about 10, about 1 to about 9, about 1 to about 8, about 1 to about 7, about 1 to about 6, about 1 to about 5, about 1 to about 4, about 1 to about 3, or about 1 to about 2 seconds. In some embodiments, the treatment agent is contacted with the solids for about 0.5 to about 10, about 0.5 to about 9, about 0.5 to about 8, about 0.5 to about 7, about 0.5 to about 6, about 0.5 to about 5, about 0.5 to about 4, about 0.5 to about 3, about 0.5 to about 2, or about 0.5 to about 1 seconds. In some embodiments, the treatment agent is contacted with the solids for about 2 to about 10, about 2 to about 9, about 2 to about 8, about 2 to about 7, about 2 to about 6, about 2 to about 5, about 2 to about 4, or about 2 to about 3 seconds. In some embodiments, the treatment agent is contacted with the solids for about 3 to about 10, about 3 to about 9, about 3 to about 8, about 3 to about 7, about 3 to about 6, about 3 to about 5, or about 3 to about 4 seconds. In some embodiments, the treatment agent is contacted with the solids for about 4 to about 10, about 4 to about 9, about 4 to about 8, about 4 to about 7, about 4 to about 6, or about 4 to about 5 seconds. The time periods described herein can be used in conjunction with any embodiment of the processes described herein involving the contacting of a solid with a treatment agent. The phrase “time period as described herein” refers to these time periods in addition to any time periods described specifically with any particular embodiment. A proppant solid may also be referred to as a particulate core. The particulate core, just as is the case for proppant solids described herein, can be coated or treated according to the various compositions and methods described herein.

In some embodiments, the treatment agent to prepare the light weight proppant is presented as an aqueous solution, dispersion, or emulsion. In some embodiments, suitable levels of the treatment agent can be characterized as a weight of applied solids per unit weight of treated solids. In some embodiments, with such a reference frame, suitable application rates of treatment agent are less than 5 wt % treating agent solids per unit weight of treated solid (e.g. sand). In some embodiments, the treatment agent is applied at a rate of less than about 3 wt % and without adversely affecting free-flowing characteristics by the treated proppants after the applied materials have dried. In some embodiments, the applied materials are an agent comprising a compatibilizing agent and/or a hydrophobic polymer. In some embodiments, the treatment agent is applied at an amount from about 0.0002 to about 1.5 wt %, about 0.0002 to about 1 wt %, about 0.0005 to about 0.85 wt %, about 0.0007 to about 0.75 wt %, about 0.0008 to about 0.65 wt %, about 0.0009 to about 0.5 wt %, about 0.001 to about 0.35 wt % and about 0.0013 to about 0.25 wt %. In some embodiments, the amount of the treatment agent is from about 3 to about 8 lb of the treatment agent per ton of proppant solid. In some embodiments, the solids can be contacted with the treatment agent at a rate of about 400 tons/hour at commercial application rates depending on the equipment used. In some embodiments, the about 3 to about 8 lb of treatment agent is based upon a dispersion that has about 40% solids. For the avoidance of doubt, the solid can also be referred to as the particulate core herein.

As described herein, in some embodiments, the solids are contacted with the treatment agent very quickly thereby making the process amenable to treatment rapidly, “on-the-fly”, at loading, handling in transport or at unloading events. As described herein, the solids can be contacted with the treatment for short periods of time, which include, but are not limited to for a period of time that is less than five seconds, but greater than zero. In some embodiments, the time period is about 1 to about 3 seconds. In some embodiments, the solids are contacted with the treatment agent in the time it takes the solids to fall 3-4 feet (1-1.3 m). In some embodiments, the treatment agent is contacted with the solids using a spray dispersion nozzle. In some embodiments, the treatment agent is contacted with the solids via a plurality of spray dispersion nozzles that impinge on a falling or guided falling stream of proppants, or which introduce the treatment agent onto the proppant solids as the solids are pneumatically conveyed for loading or unloading.

The treatment agent can be contacted with the solids in any way that is effective to provide the solids with a substantially uniform dispersion of treatment agent over as much of the solids within the treatment zone as is reasonably possible. The methods can be dependent, for example, on the existing equipment, budget and space. In some embodiments, the contacting equipment is a spraying system of at least one nozzle that distributes the treatment agent over, under, around and within the treated solids as they move past and through the treatment zone. In some embodiments there are a plurality of nozzles.

In some embodiments, a typical treatment zone might be located along a conveyor belt as proppants are unloaded from a transport vehicle and conveyed by a belt to discharge equipment. In some embodiments, a treatment zone includes 1 to 8 nozzles and/or atomizing spray nozzles, to create a fine spray, mist or fog that contacts the moving proppants from both above and below the conveyor belt or as the solids fall from the conveyor belt to effect a substantially uniform treatment.

In some embodiments, the treatment zone could be within an enclosure located around the conveying system/belt to better contain the treatment additive as it is applied, to better control the environment around the application point, or to make the contacting process more efficient.

In some embodiments, the solids can also be heated or allowed to become heated to an elevated temperature, i.e., at a temperature above 25° C. or from about 30° to about 85° C., immediately before or after the contacting step so that higher concentrations of the treatment agent can be applied to increase performance or allow a less expensive additive to be utilized. As described herein, in some embodiments, the solids are not heated or allowed to become heated to an elevated temperature prior to application of the treatment. This does not include when the solids are introduced downhole into a well where the temperature is increased.

In some embodiments, another treatment zone might be located in or in conjunction with a pneumatic conveyor. One or more spray nozzles (e.g. fine spray nozzles) can be aligned and directed to discharge the treatment agent into the pneumatic air stream at one or more locations at the appropriate injection rate so as to contact the conveyed solids as they are mixed and moving in the conveyance stream.

In some embodiments, treatment zones are located at one or more transfer points within the handling process where the solids are in motion and sufficient mixing can be performed readily. In some embodiments, they are mixed with a static mixer to enhance mixing of the treated solids and encourage a substantially even distribution of the treatment agent over the solids. In some embodiments, the locations include loading ports where stored proppant solids are delivered for transport to a delivery truck, discharge ports used for loading pneumatic transport trucks, and discharge belts when a truck unloads proppants at a well site. In some embodiments, the process comprises applying a first treatment agent with a first spray assembly onto the solids for a period of time as described herein; passing the treated solids through a static mixer; and applying a second treatment agent with a second spray assembly onto said solids for a period of time as described herein. In some embodiments, the first treatment agent and the second treatment agent are different. In some embodiments, the first treatment agent is a compatibilizing agent. In some embodiments, the second treatment agent is a hydrophobic polymer. In some embodiments, there is only one treatment agent that comprises both the compatibilizing agent hydrophobic polymer. Thus, in some embodiments, they are added simultaneously or sequentially.

In some embodiments, the second treatment is applied to the solids immediately after the solids are passed through the static mixer. In some embodiments, at least one of the first and second treatment agents is effective to coat the solids with a dust reduction coating. In some embodiments, at least one of the first and second treatment agents is effective to coat the solids with a hydrophobic polymer as described herein. In some embodiments, at least one of the first and second treatment agents is effective to coat the solids with a compatibilizing agent as described herein. In some embodiments, at least one of the first and second treatments is effective to coat the solids with an additional coating. In some embodiments, the additional coating is a hydrophobic coating, dust reduction coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, or a coating comprising an ion exchange resin that removes anions and/or halogens. Such coatings are described herein, but other coatings can also be applied in a similar manner.

In some embodiments, the treatment agent is contacted and mixed with the proppant solids (particulate core) at a transfer point location where the proppant solids are discharged and experience some period of free fall to a vertically lower point. Such locations permit the use of one or more spray nozzles. For example, 1 to 12 nozzles in 1 to 3 stages can be disposed around the falling solids such as around a discharge port in a substantially circular pattern. In some embodiments, multiple nozzles are used. In some embodiments, multiple nozzles are used each with a fan-shaped or conical spray pattern that are aligned and aimed to spray the falling solids with the treatment agent and coat the solids. In some embodiments, the contacting occurs immediately before, during, and/or after passage through a static mixer that uses the momentum of the falling solids to encourage better mixing and distribution of the treatment agent over the solids. A non-limiting example of such a system can be found in U.S. application Ser. No. 14/528,070, which is hereby incorporated by reference in its entirety.

Accordingly, in some embodiments, a process for preparing light weight proppants is provided. The process can be any treatment described herein or another process. In some embodiments, the process comprises contacting the solids less than five seconds with a treatment agent with an amount of the treatment agent that substantially retains free-flowing characteristics of the treated solids. The treatment agent can be any agent described herein and contain one or more of the compositions described herein. In some embodiments, the solids are contacted with the treatment agent more than once and each contacting step is for less than five seconds. The time period for contact can also be any time period as described herein.

The processes described herein are suitable for applying coatings or agents to various finely divided proppant solids. Examples include, but are not limited to, uncoated sand, sand with a cured or partially cured coating, bauxite, ceramic, coated bauxite, or ceramic. In some embodiments, the finely divided proppant solids are uncoated sand or resin-coated sand.

In some embodiments, the process comprises spraying the treatment agent onto the proppant solids while the solids are in free fall, guided free fall, or during pneumatic transport. Other embodiments are described herein can also be part of the process. The solids can also be sprayed substantially simultaneously from more than one direction.

As described herein, the processes described herein can be used to apply a dust reduction coating. The processes can also be used to apply a compatibilizing agent and/or a hydrophobic polymer. The treatment agent can also be effective or used to coat the solids with any one or more of: a hydrophobic coating, a coating that reduces friction, a coating that comprises a tracer, an impact modifier coating, a coating for timed or staged release of an additive, a coating that controls sulfides, a different polymeric coating, an acid or base resistant coating, a coating that inhibits corrosion, a coating that increases proppant crush resistance, a coating that inhibits paraffin precipitation or aggregation, a coating that inhibits asphaltene precipitation, and/or a coating comprising an ion exchange resin that removes anions and/or halogens, or any combination thereof. Examples of such coatings are described herein.

In some embodiments, the dust reducing treatment agent comprises an emulsion of ethoxylated, propoxylated C₆-C₁₂ alcohols, ethoxylated, propoxylated C₁₀-C₁₆ alcohols, acrylic polymers, and water. In some embodiments, the dust reducing treatment agent comprises a surfactant. In some embodiments, the dust reducing treatment agent comprises less than 0.1% aqueous ammonia. In some embodiments, the dust reducing treatment agent comprises less than 0.05% free (e.g. residual) monomers. In some embodiments, the dust treatment agent comprises about 15% to about 30%, about 17 to about 28%, or about 20% to about 25% of ethoxylated, propoxylated C₆-C₁₂ alcohols. In some embodiments, the dust treatment agent comprises about 5% to about 20%, about 8 to about 18%, or about 10% to about 15% of ethoxylated, propoxylated C₁₀-C₁₆ alcohols. In some embodiments, the dust reducing reagent comprises about 20% to about 25% of ethoxylated, propoxylated C₆-C₁₂ alcohols, about 10% to about 15% of ethoxylated, propoxylated C₁₀-C₁₆ alcohols, about 5% to about 10% acrylic polymers, less than 0.1% ammonia, less than 0.05% free monomers. In some embodiments, the dust reducing reagent comprises about 20% to about 25% of ethoxylated, propoxylated C₆-C₁₂ alcohols, about 10% to about 15% of ethoxylated, propoxylated C₁₀-C₁₆ alcohols, about 5% to about 10% acrylic polymers, less than 0.1% ammonia, less than 0.05% free monomers with the remaining being water. The dust reducing treatment agent can also be combined with the compatibilizing agent and/or the hydrophobic polymer. In some embodiments, the dust reducing treatment agent is an agent comprising the compatibilizing agent and the hydrophobic polymer.

Various treatment agents are described herein. The treatment agents can be applied to the solids, particulates, or proppants, or by whatever name they may be referred to, according to any of the various embodiments described herein. The treatment agents can be applied simultaneously or consecutively. Additionally, the processes described herein can be used to add multiple layers or coatings to the solids. The treatment agents can also be applied singularly or in any combination with one another. The process is not limited to applying any one coating, unless explicitly stated to the contrary.

The treatment agent that can be used in the methods described herein can be an aqueous solution or emulsion. In some embodiments, the treatment agent can be used to reduce dust produced by the solids.

In some embodiments, proppant is treated with a treatment agent that can be used to enhance the hydrophobicity of the solids. The treatment agent can be used to enhance particulate (solids) transport as compared to a particulate without the enhanced hydrophobicity. In some embodiments, the treatment agent(s) dextrose, maltose and/or polyol selected from arabitol, erythritol, or mixtures thereof. See also U.S. Pat. Nos. 6,790,245 and 7,157,021. In some embodiments, the particulate is not coated with a sugar or a starch.

The proppants (solids) can also be treated with non-limiting examples of surfactants and alkoxylated alcohols that can be used include, but are not limited to, C₁₀-C₁₄ alpha-olefin sulfonates, C₁₀-C₁₆ alcohol sulfates, C₂-C₁₆ alcohol ether sulfates, C₂-C₁₆ alpha sulfo esters, highly branched anionic surfactants, nonionic surfactants that are block copolymers of molecular weight less than 600 and derived from ethylene oxide/propylene oxide or other epoxide, nonionic surfactants that are C₈-C₁₆ branched alcohols that have been ethoxylated with four to ten moles of ethylene oxide per mole alcohol, and mixtures thereof. For example, see the coal dust treatment described in CA Patent No. 2,163,972 and U.S. Pat. No. 4,592,931. See also U.S. Pat. Nos. 6,372,842; 5,194,174; 4,417,992 and 4,801,635. Other examples include those described in EP01234106A2; U.S. Pat. No. 3,900,611; U.S. Pat. No. 3,763,072; WO 2005/121272 and U.S. Patent Application Publication No. 2007/073590. Any overlap in molecular length in the above ranges is due to the realities of commercial production and separation and would be so recognized by those in this technology. These can also be used as compatibilizing agents.

A variety of water soluble or water-dispersed polymers or polymer emulsions can also be a part of the treatment agent to prepare light weight proppants. Examples include, but are not limited to, acrylic polymers and copolymers, methacrylic polymers and copolymers of acrylic acid and/or methacrylic acid. Examples of alkoxylated alcohols that can be used include, but are not limited to, acrylic acid copolymers of acrylic acid and one or more of unsaturated aliphatic carboxylic acids such as 2-chloroacrylic acid, 2-bromoacrylic acid, maleic acid, fumaric acid, itaconic acid, methacrylic acid, mesaconic acid or the like or unsaturated compounds copolymerizable with acrylic acid, for example, acrylonitrile, methyl acrylate, methyl methacrylate, vinyl acetate, vinyl propionate, methyl itaconate, styrene, 2-hydroxylethyl methacrylate, and the like. These can also be used as compatibilizing agents. For example, tailoring the monomer ratios (polar:nonpolar) allows for tailoring of the hydrophilicity. Use of block copolymers would allow for formation of domains of hydrophobic and hydrophilic domains, and thus act as a compatiblizer (i.e., hydrophilic associate with water or the silica surface, hydrophobic would associate with the hydrophobic polymer).

In some embodiments, the polyacrylic acid or acrylic acid copolymer has a weight average molecular weight of from about 5,000 to about 30 million or from about 1 million to about 5 million. In some embodiments, the amount of acrylic polymer present in the mixture with the polybasic acid is about 2 to about 50, about 3 to about 10, or about 4, parts by weight per weight part of polybasic acid. See, U.S. Pat. No. 4,592,931 the disclosure of which is hereby incorporated by reference. These can also be used as compatibilizing agents.

Polyvinyl acetate and vinyl acrylic solutions and emulsions can also be used in the treatment agent to prepare light weight proppants. For example, water-dispersible acrylic and vinyl polymers are suitable, include but are not limited to the homo-, co-, and ter-polymers of acrylic acid, vinyl alcohol, vinyl acetate, dimethyl diacrylyl ammonium chloride (DMDAAC), acrylaminyl propyl sulfonate (AMPS) and the like, and combinations thereof.

Acrylamide polymers can also be used in the treatment agent in the preparation of the light weight proppant. Examples of acrylamide polymers include, but are not limited to, a polyacrylamide copolymer in an amount within the range from about 0.5 to about 20 wt % of the resulting mixture. In some embodiments, the acrylamide is added in an amount from about 1 to about 2 wt %. Examples of suitable acrylamides include, but are not limited to, anionic charged polyacrylamides or polyacrylamide polyacrylate copolymers with an average molecular weight from 3 million to 25 million g/mol and a charge density from 10% to 60%. Non-limiting examples of commercial acrylamide products include: AN934XD from SNF, Inc., AF306 from Hychem, Inc., and Magnafloc 336 from CIBA.

The polyacrylamide can be used alone or in combination with a starch that has been modified for enhanced solubility in cold water. See U.S. Pat. No. 5,242,248 (polyacrylamide treatment for horse arenas) and Published U.S. Patent Application Publication No. 20130184381, the disclosures of which are hereby incorporated by reference.

The treatment agent can also include one or more water-dispersible natural gums, water-dispersible pectins, water-dispersible starch derivatives, or water-dispersible cellulose derivatives. Examples of natural gums include: terrestrial plant exudates including, but not limited to, gum arabic (acacia), gum tragacanth, gum karaya, and the like; terrestrial plant seed mucilages, including but not limited, to psyllium seed gum, flax seed gum, guar gum, locust bean gum, tamarind kernel powder, okra, and the like; derived marine plant mucilages, including but not limited to, algin, alginates, carrageenan, agar, furcellaran, and the like; other terrestrial plant extracts including but not limited to arabinogalactan, pectin, and the like; microbial fermentation products including but not limited to xanthan, dextran, scleroglucan, and the like. Cellulose derivatives include chemical derivatives of cellulose, including but not limited to, alkyl, carboxyalkyl, hydroxyalkyl and combination ethers, and the sulfonate and phosphate esters.

In some embodiments, the guar gum is a solution whose viscosity can be adjusted to accommodate variations in the treated solids. For example, the viscosity of a guar gum solution can be adjusted by treatment with gamma radiation to achieve a viscosity of about 40 to about 140 cps at 1% concentration at application temperature. Guar gum (such as that sold by Rantec, Inc. under the trade names Super Tack, C7000, J3000, and HVX); carboxymethyl guar gum (such as CM Guar sold by Maharashtra Traders); carboxymethyl cassia seed powder (such as CM Cassia sold by Maharashtra Traders); carboxymethyl cellulose (such as FinnFix300 sold by Noviant); starch (corn, maize, potato, tapioca, and wet milled/spray dried starch such as GW8900 sold by KTM Industries); starches pre-treated with crosslinking agents such as epiclorohydrin and phosphorus oxychloride; Carboxymethyl starch (0.2 to 0.3 degree of substitution (DS), such as AquaBloc, KogumHS, RT3063 and RT3064 sold by Process Products N.W.); hydroxypropyl guar gum; hydroxyethyl guar gum; carboxymethyl-hydroxypropyl guar gum; ethyl starch; oxidized starch; and hydroxyethyl cellulose. Other examples of polymers include Cassia seed powder, psyllium husk powder, xanthan gum, any cereal grain, annual or perennial dicot seed derived polysaccharide (sesbania, locust, bean gum, flax seed, and gum karaya).

In some embodiments, prior to the addition of guar gum, the water for the treatment agent formulation can be treated with a crosslinking agent made with a blend of one part glyoxal and two parts zirconium lactate (e.g., the DuPont product sold under the brand name TYZOR 217) at a rate of 30 to 50 parts crosslinking agent per 100 parts of polymer. For example, to 15 gallons of water (125.1-1b) a dose of 1.75-lb of guar gum is to be added; prior to the polymer addition a dose of 0.70-lb of crosslinking agent (40% of 1.75-lb of polymer) is added. The guar gum polymer can, in some embodiments, be added to the water at a rate of 0.70% to 1.4% by weight. A plasticizer, glycerin, can also be added at a rate of 0.5 to 5% by weight of the guar gum solution. In some embodiments, the cross-linker is after the guar gum is hydrated in the water.

Water-dispersible starch derivatives include, but are not limited to, alkyl, carboxyalkyl, hydroxyalkyl and combination ethers of starch, phosphate or sulfonate esters of starch and the like which are prepared by various chemical or enzymatic reaction processes.

The products described herein can be contacted with the solids as described herein. The processes are not limited to the specific examples. Other liquid, dust suppression, treatment agents that are typically commercially available and described as useful for controlling unpaved road dust, dust from storage piles, and similar structures can also be used. Such agents can be aqueous or solvent-based, but are not just water or a volatile solvent. That is, in some embodiments, a treatment agent is not water or a volatile solvent not containing any other components.

In some embodiments, the treatment agent can be in the form of thin coatings that can cure by contact with ambient water or moisture, e.g., an alkyl that can cure on exposure to moisture.

In some embodiments, the treatment agent comprises a light mineral oil which can be contacted with the proppant solids in the form of a light oil or in an aqueous form with a surfactant. In some embodiments, an oil is not used. Mineral oils that can be used as/in the treatment agent include, but are not limited to, mineral oils characterized by a pour point of from about 30° F. to about 120° F., a viscosity from about 50 SSU to about 350 SSU at 100° F., a distillation temperature above about 500° F., a distillation end point below about 1000° F., a distillation residue of not more than about 15%, and an aromatic content of not more than about 60%.

In some embodiments, mineral oils are characterized by a pour point of from about 35° F. to about 100° F., a viscosity from about 100 SSU to about 310 SSU at 100° F., a 10% distillation temperature from about 500° F. to about 700° F., a distillation end point below about 900° F., a distillation residue of not more than about 15%, and an aromatic content of not more than about 50%.

The processes described herein can also be used to apply other coatings to proppants. Such other coatings can provide the proppants with additional, functional properties at the same time as the dust control treatment or an independent treatment step. Such other coatings can include the following. The processes can also be used to provide a coating that does not result in fugitive dust control.

Water barriers can also be used to prepare light weight proppants and can be useful to prevent reaction or dissolution of proppant under acidic or basic conditions downhole. Chemical reactions of proppant are known to cause reductions in crush resistance, and potential scale formation through diagenesis, i.e., dissolution of the proppant and re-precipitation with dissolved minerals in the formation water.

A water resistant coating can be formed by contacting the proppant solids with one or more organofunctional alkoxy silanes to develop a hydrophobic surface. Examples of organofunctional alkoxy silanes include, but are not limited to, waterborne or anhydrous alkyl or aryl silanes. Triethoxy [(CH₃CH₂O)₃SiR] or trimethoxy [(CH₃O)₃SiR] where R represents a substituted or unsubstituted alkyl or substituted or unsubstituted aryl moiety, silanes and chlorosilanes could be used as well if a lower reaction temperature and higher speed of reaction are necessary. It should be noted that HCl can be generated as a byproduct of the treatment process, which can cause issues with corrosion. Therefore, in some embodiments, corrosion-resistant treatment heads and handling equipment immediately after the chlorosilane treatment can be used.

In some embodiments, if a hydrophobic and oleophobic surface is required, treatment of the proppant with a fluoroalkyl silane is performed. A hydrophobic coating can also be applied by utilizing the compatibilizing agent and hydrophobic polymers described herein.

If a thicker crosslinked, polymeric coating is needed for enhanced durability and hydrophobicity, a polymer can be applied after the silane treatment. In such a treatment, the silanes can include, but are not limited to, a triethoxy [(CH₃CH₂O)₃SiR], or trimethoxy [(CH₃O)₃SiR] silane, where the R can include a functional group that could either react with crosslinkable polymers after they are applied on the surface of the proppant, or can be chemically compatible with the polymer for van der Waals force of adhesion of the polymer. In some embodiments, the R Groups for the silanes include, but are not limited to:

amines (for preparation or polyurethanes, polyureas, polyamides, polyimides or epoxies. Amines can also be used for polysulfones);

isocyanates (for polyurethane, polyurea coatings);

vinyl (for reaction with polybutadiene, polystyrenebutadiene, other addition type olefinic polymers, or reaction with residual vinyl groups in any copolymer blends used as coatings);

epoxides (for reaction with epoxies);

methacrylate or ureido groups (for polyacrylates); and

phenyl groups (for use with aromatic-containing polymers such as the polyaryletherketones (PAEKs) and their composites such as polyetherketoneketone (PEKK)/50:50 terephthallic:isothallic/amorphous polyetherketoneetherketoneketone (PEKEKK), polyethersulfone (PES), polyphenylsulfone (PPSU), polyetherimine (PEI), or poly(p-phenylene oxide) (PPO)).

The thicker, crosslinked, polymeric coatings can be prepared by a first step of application of silanes, followed by a second step of flash coating with the polymer, prepolymers, or monomers. As used herein, the phrase “flash coating” refers to the process of applying the agent according to a process described herein. In some embodiments, catalysts can be used for inducing reactions at typical operating temperatures of the flash coating process, i.e. room temperature to 85° C. In some embodiments, methoxysilanes tend to react faster than ethoxy silanes, so methoxysilanes can be used for fast, flash-type coatings. If speed of reaction of the silane treatment is a limiting factor for proper coating, chlorosilanes can be used as substitutes for methoxy or ethoxysilanes. In some embodiments, corrosion resistant materials are used in the application process. An example of “flash coating” can be found in U.S. application Ser. No. 14/528,070, which is hereby incorporated by reference in its entirety.

In some embodiments, methods for forming flash coatings of high temperature aromatic polymers use a solvent-based slurry or fully dissolved solution. Suitable solvents include, but are not limited to, N-methylpyrrolidone (NMP), dimethylformamide (DMF), and dimethylsulfoxide (DMSO). If excess solvents remain after application, they can be removed via a drying step prior to transfer into containers for shipment.

Suitable materials for flash coating or coating the light weight proppants with such hydrophobic and/or oleophobic agents include, but are not limited to, superhydrophobic coatings such as those found in U.S. Pat. No. 8,431,220 (hydrophobic core-shell nano-fillers dispersed in an elastomeric polymer matrix); U.S. Pat. No. 8,338,351 (hydrophobic nanoparticles of silsesquioxanes containing adhesion promoter groups and low surface energy groups); U.S. Pat. No. 8,258,206 (hydrophobic nanoparticles of fumed silica and/or titania in a solvent); and U.S. Pat. No. 3,931,428 (hydrophobic fumed silicon dioxide particles in resin) and the durable hydrophobic coatings of U.S. Pat. No. 8,513,342 (acrylic polymer resin, polysiloxane oil, and hydrophobic particles); U.S. Pat. No. 7,999,013 (a fluorinated monomer with at least one terminal trifluoromethyl group and a urethane resin); and U.S. Pat. No. 7,334,783 (solid silsesquioxane silicone resins), or any combination thereof. Additional materials that can be used include, but are not limited to, aliphatic or aromatic polymers that exhibit water contact angles of greater than about 90°, such as polybutadiene-containing polymers, polyurethanes with high proportions of soft segments (e.g., aliphatic segments), polymethylmethacrylate, and siloxane resins, including polydimethylsiloxane, or any combination thereof.

The use of a hydrophobic coating on the light weight proppant can also have the effect of preventing water from reaching the surface of the sand grain. Therefore, a hydrophobic coating can be used to slow down or minimize the detrimental effects that are observed with increased temperature in water-rich environments like those found downhole. The hydrophobic coating can be a coating comprising the compatibilizing agent and the hydrophobic polymer described herein.

In some embodiments, the proppant is coated with multiple coatings. In some embodiments, the proppant is coated with a first layer of hydrophobic/oleophobic coating followed by a turbulence-reducing coating. Such a layered structure can permit the treated proppant to both reduce turbulence from separation of the top layer and then reduce surface drag by the flowing fluids by the underlying layer. In some embodiments, the particulate (proppant) is coated with the coating comprising the compatibilizing agent and the hydrophobic polymer followed by, or simultaneously with, a turbulence-reducing coating.

Friction reducing coatings can also take the form of materials with a low external, interparticle friction that function as a slip aid. A suitable material for use as such an slip aid is a product sold under the tradename POLYOX from Dow Chemical. This material is a non-ionic water-soluble poly(ethylene) oxide polymer with a high-molecular weight.

Tracer Coatings.

The light weight proppant can also have a tracer. Tracers are radioactive isotopes or non-radioactive chemicals that are injected in a well at specific sites with the intent that they will come out in detectable levels at some point in the effluent. Thus, they allow flow tracking of injected fluids from the source of introduction to the effluent stream. In addition, tracers that are location-specific can be used to track production of fluids from specific areas/zones in a well. Often, the tracers are introduced as an additive into the fracturing fluid during completion of a particular zone of interest. The tracers can also be incorporated into the coating comprising compatibilizing agent and the hydrophobic polymer

Common radio-isotope chemistries used as tracers include tritiated water (³H₂O); tritiated methane (³CH₄); ³⁶Cl—¹³¹I—; ³⁵SO₄²⁻; S¹⁴CN⁻; H¹⁴CO³⁻; and ²²Na⁺.

Common non-radioactive tracer chemicals include halohydrocarbons, halocarbons, SF₆, and cobalt hexacyanide, where the cobalt is present as an anionic complex because cationic cobalt can react and precipitate downhole. Various organic compounds of usefulness include sulfonic acids and salts of those acids, mapthalenediol, aniline, substituted analine, and pyridine.

Tracers can be embedded in proppants but usually require actual movement of the proppant particle out of the well (i.e., flowback). The tagged proppant particle itself is then collected as a sample and analyzed for the presence/absence of the tracer. See U.S. Pat. Nos. 7,921,910 and 8,354,279. Others have sought to incorporate non-radioactive tagging chemicals into the proppant resin coating, but such an introduction method has required custom proppant formulations that must be manufactured well in advance of planned usage in a particular well. This can cause issues as the reactive phenolic coated proppants can sometimes have short useful shelf life as the taggants must be released before the phenolic resin becomes fully cured.

One feature in common among the tagged proppant techniques to date is that all of them require substantial pre-planning for production of multiple, different, tagged proppants for different well zones in advance of injection. For example, if five different zones need to be mapped, five different tagged proppant formulations might be needed. This means that five different types of proppants must be prepared at the resin coating plant and stored in inventory by either the proppant manufacturer or by the well completion group.

In some embodiments, the present methods and processes occur so quickly and with such small amounts of applied polymers, resins, or organic compounds that the same tracers, metals, salts and organic compounds could be used as have been used previously in resin coating facilities. Additionally, new polymers or oligomers can be used that contain specific functional groups that have not been previously used, such as fluorescent dyes or phosphorescent pigments that can be detected in even small quantities in produced effluent, whether water or hydrocarbon. Suitable fluorescents include coumarins, napthalimides, perylenes, rhodamines, benzanthrones, benzoxanthrones, and benzothioxanthrones. Phosphorescent pigments include zinc sulfide and strontium aluminate. The coating used in the present process can be tailored to allow for selective or timed release leaching of the tracer salts from the coating into the downhole environment. This would allow the effluent to be used for analysis rather than requiring an analysis of recovered proppants in the flowback. In addition, very short lead times can be gained through use of this process, to allow greater flexibility for the customer to specify numbers of different tagging sections needed in a particular well. In some embodiments, the coatings applied by the processes described herein are applied immediately before moving the sand from terminals into containers for shipment to the well pad. This means that the inventory is reduced to the containers of tracer agent.

Some metal agents, e.g., tin and copper, that were previously used as biocides can also serve the function of a tracer in a proppant coating.

Suitable polymers to prepare tracer coatings include acrylate copolymers with hydrolysable silylacrylate functional groups, such as those described by U.S. Pat. No. 6,767,978. Briefly described, such polymers are made from at least three distinct monomers units selected from the group consisting of fluorinated acrylic monomers, (e.g. 2,2,2-Trifluoroethylmethacrylate (matrife)), triorganosilylacrylic monomers, (e.g., trimethylsilyl methacrylate) and acrylic monomers not containing an organosilyl moiety, (e.g. methyl methacrylate). The three component polymer (i.e. terpolymer) can optionally contain from 0-5 weight percent of a crosslinking agent. Such polymers are a copolymers comprising the reaction product of:

a) a monomer of the formula:

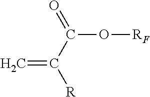

wherein:

R is CH₃ or H, and

RF is (C)ᵤ(CH)ᵥ(CH₂)_{w}(CF)ₓ(CF₂)_{y}(CF₃)_{z} where u is from 0 to 1, v is from 0 to 1, w is from 0 to 20, x is from 0 to 1, y is from 0 to 20, z is from 1 to 3, and the sum of w and y is from 0 to 20,

b) a monomer of the formula:

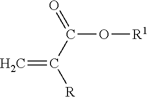

wherein: R is CH₃ or H, and R¹ alkyl or aryl, and

c) a monomer of the formula:

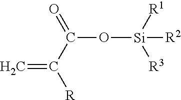

wherein:

R is CH₃ or H, and

R¹, R², and R³ can be the same or different and are non-hydrolysable alkyl groups containing from 1 to 20 carbon atoms and/or non-hydrolysable aryl groups containing from 6 to 20 carbon atoms.

In addition, depending on the chemistry used, metal-containing tracer moieties can also be used as biocides, similar to marine antifouling coatings. For example, tin and copper are commonly used as biocides in marine paints. These metals or their salts could also be incorporated into the acrylate latexes for flash coating onto the proppant or added to insoluble polymers for permanent attachment to the exterior of the proppant surface.

Suitable water soluble and dissolvable polymers are described in U.S. Pat. No. 7,678,872. Such polymers can be applied to proppants according to the present flash coating process to allow for introduction timed release functionality of the tracers into the produced fluid as the polymer swells or dissolves while also serving to control fugitive dust from the proppant.

Impact Modifiers.

Light weight proppants can also have impact modifiers. Fines in a well can severely affect the conductivity of a proppant pack. Production of 5% fines can reduce conductivity by as much as 60%. Particle size analysis on pneumatically transferred 20/40 sand with a starting fines distribution of 0.03% showed an increase in fines to 0.6% after one handling step, and 0.9% after two handling steps prior to shipment to a well pad. Transport and further handling at the well site will likely also produce significantly more impact-related fines.

The processes described herein can be used to coat proppants with polymers specifically designed to be more deformable, which will greatly aid in the reduction of impact induced fines production. These polymers reduce the number of grain failures when closure stress is applied, effectively increasing the K value of the proppant, and can reduce fines migration by keeping failed grains encapsulated.

There are at least three ways that a thin, deformable coating on a proppant can improve fracture conductivity. The first is a benefit addressing the handling process. An additive that controls/prevent the generation of dust (through handling and pneumatic transfer) is helping to minimize the generation and inclusion of fine particles that are created through movement of such an abrasive that material as uncoated sand. Without wishing to be bound by any theory, the process that causes the creation of fines is simultaneously creating weakened points everywhere the grain was abraded. Conductivity tests have documented that uncoated sand samples that were moved pneumatically had measurably lower conductivity than the same sand not so handled. The impact-modifying polymer coating can further reduce grain failure by spreading out point-to-point stresses that occur when one grain is pushed against another during the closure of the fracture and subsequent increase of closure stress that occurs as the well is produced. The deformable coating effectively increases the area of contact between two grains. This increase in contact area reduces the point loading that is trying to make the grains fail. Minimizing the generation of fines that occur either during handling or from the pressure applied in the fracture, will mean there are less fines that can be mobilized to create conductivity damage. If the flash coating results in a uniformly distributed film around the sand grain, the coating can be an effective means of preventing fines movement through the encapsulation of any failed grains. Preventing or minimizing the movement of fines can result in controlling a condition that has been proven to be capable of reducing fracture conductivity by as much as 75%.

In some embodiments, for an impact modified layer, the layer comprises lower Tg polyurethanes or lightly crosslinked polyurethanes. The polyurethane formula could be tailored for lower Tg and better resilience by using a very soft polyols (e.g., polybutadiene-based polyols with very light crosslinking). Another embodiment uses the application of a thin coating of polybutadiene polymer as the impact layer. Such a flash coating is applied with either a latex-based or solvent-based formulation, and a peroxide for lightly curing/crosslinking the polybutadiene coating. Other embodiments include, but are not limited to, other rubbery polymers including polyisoprene, polychloroprene, polyisobutylene, crosslinked polyethylene, styrene-butadiene, nitrile rubbers, silicones, polyacrylate rubbers, or fluorocarbon rubbers. The rubber or gum should be in a water-based latex or dispersion or dissolved in a solvent for spray application.

Polybutadiene coatings with unreacted vinyl or alkene groups can also be crosslinked through use of catalysts or curative agents. When catalysts, fast curatives, or curatives with accelerants are introduced during processes described herein, the result will be a very hard, tough coating. Alternately, curative agents can be added that will activate thermally after the materials are introduced downhole at elevated temperatures. This may have the effect of having a soft rubbery coating to protect against handling damage, but that soft rubbery coating could then convert to a hard coating after placement downhole at and cured elevated temperatures.

Curative agents that can be used are those that are typically used for rubbers, including sulfur systems, sulfur systems activated with metal soaps, and peroxides. Accelerators such as sulfonamide thiurams or guanadines might also be used, depending on cure conditions and desired properties. Other curing catalysts could also be employed to perform similarly include ionic catalysts, metal oxides, and platinum catalysts.

Additive Delivery.

“Self-suspending proppants” can have an external coating that contains a water swellable polymer that changes the proppant density upon contact with water. See, for example, U.S. 2013/0233545. Such coatings are taught to have about 0.1-10 wt % hydrogel based on the weight of the proppant and can contain one or more chemical additives, such as scale inhibitors, biocides, breakers, wax control agents, asphaltene control agents and tracers. Since the effect of the hydrophobic polymer, along with, for example, the introduction of nitrogen, has the net effect of decreasing the density of particles through attachment of bubbles and imparting flotation capability, the coatings described herein comprising the hydrophobic polymer and the compatibilizing agent can also be referred to as a self-suspending proppant.

In some embodiments, the water swellable polymer can be applied by processes described herein and present at a much lower concentration, e.g., less than about 0.1 wt %, or from about 0.001 to about 0.07 wt %. At such low levels, the swellable coating is unlikely to produce a self-suspending proppant but, rather, imparts enhanced mobility relative into the fracture to untreated sand while also providing dust control as well as a delivery system upon contact with water for biocides and tracers. For example the swellable polymer coating could act as a dust control when first applied, could swell to enhance mobility for placement, and could also contain tracers, biocides, or other active ingredients that could be released over time through diffusion out of the swollen polymer.

Soluble and semi-soluble polymers that can be used as delivery coatings include, but are not limited to, 2,4,6-tribromophenyl acrylate, cellulose-based polymers, chitosan-based polymers, polysaccharide polymers, guar gum, poly(l-glycerol methacrylate), poly(2-dimethylaminoethyl methacrylate), poly(2-ethyl-2-oxazoline), poly(2-ethyl-2-oxazoline), poly(2-hydroxyethyl methacrylate/methacrylic acid), poly(2-hydroxypropyl methacrylate), poly(2-methacryloxyethyltrimethylammonium bromide), poly(2-vinyl-1-methylpyridinium bromide), poly(2-vinylpyridine n-oxide), polyvinylpyridines, polyacrylamides, polyacrylic acids and their salts (crosslinked and partially crosslinked), poly(butadiene/maleic acid), polyethylenglycol, polyethyleneoxides, poly(methacrylic acids, polyvynylpyrrolidones, polyvinyl alcohols, polyvinylacetates, sulfonates of polystyrene, sulfonates of polyolefins, polyaniline, and polyethylenimines, or any combination thereof.

Biocidal Coatings.

The light weight proppants can also have a biocidal coating or additive. A number of nonpolymeric biocides have been used in fracturing fluids. Any of these can be used in solid forms or adsorbed into solid or dissolvable solid carriers for use as additives in an applied coating according to the present disclosure to impart biocidal activity to the proppant coatings. Exemplary biocidal agents include, but are not limited to: 2,2-dibromo-3-nitrilopropionamide (CAS 10222-01-2); magnesium nitrate (CAS 10377-60-3); glutaraldehyde (CAS 111-30-8); 2-bromo-2-cyanoacetamide (CAS 1113-55-9); caprylic alcohol (CAS 111-87-5); triethylene glycol (CAS 112-27-6); sodium dodecyl diphenyl ether disulfonate (CAS 119345-04-9); 2-amino-2-methyl-1-propanol (CAS 124-68-5); ethelenediaminetetraacetate (CAS 150-38-9); 5-chloro-2-methyl-4-isothiazolin-3-one (CAS 26172-55-4); benzisothiazolinone and other isothiazolinones (CAS 2634-33-5); ethoxylated oleylamine (CAS 26635-93-8); 2-methyl-4-isothiazolin-3-one (CAS 2682-20-4); formaldehyde (CAS 30846-35-6); dibromoacetonitrile (CAS 3252-43-5); dimethyl oxazolidine (CAS 51200-87-4); 2-bromo-2-nitro-1,3-propanediol (CAS 52-51-7); tetrahydro-3, 5-dimethyl-2h-1,3,5-thia (CAS 533-73-2); 3,5-dimethyltetrahydro-1,3,5-thiadiazine-2-thione (CAS 533-74-4); tetrakis hydroxymethyl-phosphonium sulfate (CAS 55566-30-8); formaldehyde amine (CAS 56652-26-7); quaternary ammonium chloride (CAS 61789-71-1); C₆-C₁₂ ethoxylated alcohols (CAS 68002-97-1); benzalkonium chloride (CAS 68424-85-1); C12-C14 ethoxylated alcohols (CAS 68439-50-9); C12-C16 ethoxylated alcohols (CAS 68551-12-2); oxydiethylene bis(alkyldimethyl ammonium chloride) (CAS 68607-28-3); didecyl dimethyl ammonium chloride (CAS 7173-51-5); 3,4,4-trimethyl oxazolidine (CAS 75673-43-7); cetylethylmorpholinium ethyl sulfate (CAS 78-21-7); and tributyltetradecylphosphonium chloride (CAS 81741-28-8), or any combination thereof.

Alternatively, an erodible outer coating with a timed release or staged release can be used that will dissolve and/or release included additives into the groundwater or hydrocarbons downhole. Such coatings can be based on polymers that were substantially insoluble in cool water but soluble in water at downhole temperatures where the active is intended to begin functioning shortly after introduction. Alternatively, the outer layer coating can be prepared in such a way as to render it insoluble in the well fluids and subject to release when crack closure stresses are applied.

The time frame for release of an encapsulated ingredient (biocide, scale inhibitor, etc.) via diffusion can be tailored based on the crosslink density of the coating. A polymer with little to no crosslinking can result a fast dissolving coating. Highly crosslinked materials can have a much slower release of soluble ingredients in the coating. If mobility of the chemicals of interest is too low in a crosslinked membrane, dissolvable fillers like salts, organic crystalline solids, etc. can be incorporated in the coating mixture. Once the coated proppant is introduced downhole, the particles can dissolve to leave larger pores as done for filtration membranes. See U.S. Pat. No. 4,177,228. Insoluble polymers like the thermosets (e.g., alkyds, partially cured acrylics, phenolics, and epoxies) and thermoplastics (e.g., polysulfones, polyethers, and most polyurethanes) can also be used as insoluble outer coatings applied as described herein. Alkyds, which are polyesters, are likely to hydrolyze over time under the hot, wet downhole conditions and can thereby use this property to impart a delayed release through combination of environmental hydrolysis and situational erosion. Polyamides, which can hydrolyze and degrade over time, can be used as well for this type of coating.

Coatings can be prepared by mixing thermoset polymers with the soluble fillers and applying them to the proppant particles according to the various embodiments described herein. Thermoplastic membrane coatings can be applied via dissolving in solvent, mixing with the soluble fillers, and coating the resulting mixture onto the proppant particles with subsequent removal of the solvent by drying with pneumatic conveyance air or air forced through the coated materials. Timings for release can be tailored by proper selection of filler size, shape, and filler concentration.

Biocidal polymer coatings. Biocides are often used at low concentrations in the hydraulic fracturing fluid mixtures, on the order of 0.001% in the fracturing fluid, which corresponds to approximately 0.01% of the total proppant weight. Microorganisms have a significant economic impact on the health and productivity of a well. For example, unchecked bacteria growth can result in “souring” of wells, where the bacteria produces hydrogen sulfide as a waste product of their metabolic function. Such sour gases in the produced fluids are highly undesirable and can be a source for corrosion in the production equipment as well as a cost for sulfur removal from the produced hydrocarbons.

Therefore, in some embodiments, a biocidal polymer can be applied to the proppants as an aid to both fugitive dust control as well as inhibition of bacterial growth downhole. Suitable polymers that can be used as biocides include: acrylate copolymer, sodium salt (CAS 397256-50-7), and formaldehyde, polymer with methyloxirane, 4-nonylphenol and oxirane (CAS63428-92-2), or any combination thereof.

In addition, depending on the chemistry used, metals used as marine antifouling coatings can also serve as biocides on a proppant. For example tin and copper are commonly used as biocides in marine paint. These same agents could be incorporated into the acrylate latexes for flash coating onto the proppant as a biocidal coating.

Sulfide Control.

The light weight proppants can also be prepared with sulfide controls. Hydrogen sulfide is a toxic chemical that is also corrosive to metals. The presence of hydrogen sulfide in hydrocarbon reservoirs raises the cost of production, transportation and refining due to increased safety and corrosion prevention requirements. Sulfide scavengers are often used to remove sulfides while drilling as additives in muds or as ingredients in flush treatments.

Depending on the concentration of hydrogen sulfide in the fractured reservoir, the concentrations of the scavengers included on the surface of the proppant can be varied to remove more or less hydrogen sulfide. In sufficient volume, proppants with sulfide scavenging capabilities can reduce the concentration from levels that pose safety hazards (in the range of 500-1000 ppm) to levels where the sulfides are only a nuisance (1-20 ppm). If the surface area of the proppants is high and dispersion of the scavengers is good, high efficiencies in hydrogen sulfide reaction and removal are possible.

A timed release dosage can be delivered according to the present disclosure by including copper salts, such as copper carbonate (CuCO₃), in the proppant that can be delivered very slowly into the fracture to treat hydrogen sulfide before it can reach steel components in the wellbore.

Zinc oxide (ZnO) and ferric oxide (Fe₂O₃) are used directly as solid particulates to address hydrogen sulfide. These can be incorporated onto the surface of coated proppants or be formed as functional fillers within the proppant coating that is applied. The use of high surface area fillers, even nanometer-sized particulates, can be used to maximize the interaction area between the hydrogen sulfide and the metal oxide.

Also useful are oxidizing agents, such as solid forms of oxidizing agents. Exemplary materials include solid permanganates, quinones, benzoquinone, napthoquinones, and agents containing quinone functional groups, such as chloranil, 2,3-dichloro-5,6-dicyanobenzoquinone, anthroquinone, and the like, or any combination thereof.

Polymers with pendant aldehyde groups can also be used introduce an aldehyde functionality in a light weight proppant coating for control of hydrogen sulfides. Polyurethanes can be made with such functionalities. See U.S. Pat. No. 3,392,148. Similarly, other polymers can be formed with pendant aldehyde groups, such as polyethers, polyesters, polycarbonates, polybutadiene, hydrogenated polybutadiene, epoxies, and phenolics, or any combination thereof.

In addition, dendrimers can be prepared with multiple terminal aldehyde groups that are available for reaction. These aldehyde-rich dendrimers can be used as fillers, copolymers, or alloys and applied to the proppants as a coating, or a layered coating.

Dioxole monomers and polymers allow introduction of this functionality as pendant groups in polymers. Such dioxane functional groups can serve as oxidative agents to control the production of hydrogen sulfides. Homopolymers of dioxole can be used as well as copolymers of dioxoles with fluorinated alkenes, acrylates, methacrylates, acrylic acids and the like.

Amines and triazines also used as scavengers for hydrogen sulfide. Amine-terminated polymers or dendrimers can be used and have the advantage of being tethered to a polymer so they can stay in place in a proppant coating. High functionality can be achieved by the use of dendrimers, i.e., using multiple functional groups per single polymer molecule.

Triazines can be incorporated into polyurethane crosslink bridges via attachment of isocyanates to the R groups of the triazines. See U.S. Pat. No. 5,138,055 “Urethane-functional s-triazine crosslinking agents”. Through variations of the ratio of —OH groups and the use of triol functionality and monofunctional triazine isocyanate, pendant triazines can also be prepared. These functionalized polymers can be added as fillers or prepared as the coating itself to both impart fugitive dust control as well as hydrogen sulfide control downhole.

Metal carboxylates and chelates, some of which are based on or contain zinc or iron, can be used on proppants to remove hydrogen sulfide. See U.S. Pat. No. 4,252,655 (organic zinc chelates in drilling fluid). These carboxylates or chelates are provided in the proppant coating as water soluble complexes which, upon interaction with hydrogen sulfide in-situ downhole, will form insoluble metal sulfates.

Hydrogen sulfide can also be controlled with polymers having functional groups that can act as ligands. Polycarboxylates that have been pretreated with metals to create metal carboxylate complexes can be mixed with other polymers, such as those described elsewhere herein, and applied as a coating to proppant particles. This is also applicable to other polymers with pendant functional groups that act as complexing ligands for sulfide, such as amines and ethers.

In some embodiments, the metals used for sulfide control are not present as a complex in the polymeric backbone so that removal of the metal would not have to involve polymer decomposition. Polymers with metal side chain complexes can be used. Polyvinylferrocenes, polyferrocenylacrylates are two such examples of this class of material. In some embodiments, the main chain metal containing polymer can also be used, but the polymer will degrade upon reaction with hydrogen sulfide.

If the production fluid which contains hydrogen sulfide at a basic pH (i.e., pH of greater than 7 or greater than 8-9), most of the hydrogen sulfide will be present as HS-anion. In this case, anion exchange resins or zeolites can be used to extract the HS-anions from the fluid. The zeolites or anionic exchange resins can be used as active fillers in a resin coated proppant composition include aluminosilicates such as clinoptilolite, modified clinoptilolite, vermiculite, montmorillonite, bentonite, chabazite, heulandite, stilbite, natrolite, analcime, phillipsite, permatite, hydrotalcite, zeolites A, X, and Y; antimonysilicates; silicotitanates; and sodium titanates, and those listed in U.S. Pat. No. 8,763,700, the disclosure of which is hereby incorporated by reference. Suitable ion exchange resins are generally categorized as strong acid cation exchange resins, weak acid cation exchange resins, strong base anion exchange resins, and weak base anion exchange resins, as described in U.S. Pat. No. 8,763,700. Hydrogen sulfide that is produced through biological activity is controlled through use of biocides and biocidal coatings (as discussed above), and removal of sulfate anions (HSO₄⁻ or SO₄⁻²). Anion exchange resins can be used for removal of sulfate. Nitrates can also be used to disrupt the sulfate conversion by bacterial. Nitrate salts can also be added in a coating layer and then protected from premature release with an erodible or semipermeable coating to allow an extended release of the nitrates.

Composite Coatings.

In some embodiments, the processes described can be carried out effectively in series, and such a process provides a cost-effective process to apply multiple layers of coatings with different compositions and different functional attributes. A variety of combinations are possible. For example, in some embodiments, multiple spray heads could be used, each of which can apply a different formulation. If the successive coating formulation is chemically incompatible in that the applied layer does not wet the undercoated layer, one or more primer agents, e.g., block or graft copolymers with similar surface energies and or solubility parameters as the two incompatible layers, can be used for better interfacial bonding. The different spray heads can also be used to apply the same formulation if multiple layers are desired. Some examples of composite coatings include the following.

Two layers for improved proppant physical performance. Different, successive layers are applied with different performance characteristics, such as a hard urethane layer (urethane, crosslinker (such as polyaziridine), and isocyanate) followed by an outer, softer urethane layer. This coating structure can allow some compaction for proppant particle bonding due to the soft outer layer but inhibit further compaction/crushing due to the hard inner layer. The relatively softer outer layer can also tend to reduce interparticle impact damage as well as wear damage on the associated handling and conveying equipment used to handle the proppants after the flash coating was applied.

Successive layers for a timed release functionality. Successive layers can be used to add a first layer with an additive having a first functionality followed by a second layer having properties that control when and how ambient liquids get access to the first layer additive materials. For example, a soft, lightly crosslinked urethane layer with biocide additives is covered with a hard urethane layer that contains dissolvable particles. When the dissolvable particles are removed, the outer coating forms a semipermeable coating that allows slow diffusion of the underlying biocidal additive.

Layers of strongly-bonded polymer followed by weakly-bonded polymer. A silane treatment for silica compatabilization can be applied to the sand proppant outer surface. This treatment is followed by coating with an inner polymer layer containing functional additives, such as Fe₂O₃ particulates to provide sulfide scavenging. The outer layer coating contains polyacrylamides that are loosely bonded to the first coating. Once downhole, the polyacrylamide is released and collects on the internal surfaces of metal pipes in the well. This formulation can deliver friction reduction in the short term and offer a level of sulfide control over the lifetime of the well until the iron oxide particles were fully exhausted.

Staged Release Coatings.

For example, oxygen related corrosion and asphaltene often are more problematic at the beginning of a well life cycle, while bacterial growth occurs later in the well life cycle. A composite coating of three layers can address such delayed developments. The first, innermost, layer can comprise, for example, a biocidal functionality. The second coating layer can comprise, for example, an asphaltene inhibitor, and the third layer can comprise, for example, a loosely bound polyhydroxyl compound as an oxygen scavenger. The outer layer of this proppant can reduce oxygen levels immediately, especially in dead zones/zones of limited flow from the entrance of the well, which can't be flushed with fluids containing oxygen scavengers. As the well begins production, the outer layer can be consumed and erode from the surface to expose the asphaltene-inhibiting layer of a sulfonated alkylphenol polymer that can also erode or dissolve over time. As the well continues to produce, asphaltene issues can lessen, and the remaining innermost coating can slowly release its biocides to ensure continued health of the well. A single, composite provides these extended benefits with less cost and easier logistics than the use of multiple proppants with different functions introduced into the well as a mixture.

Timed Release Coatings.

The use of an outer layer made with dissolvable particles and/or dissolvable or erodible polymers can be used to provide a controlled, timed release of functional additives much like an enteric coating of a medicament. Unlike a staged release structure, a timed release coating does not have a second stage of release. Importantly, the coated proppants according to the present disclosure provide for release over time, in situ, and throughout the fractured strata. Exemplary functional additives can include biocides, scale inhibitors, tracers, and sulfide control agents. Suitable water soluble and dissolvable polymers are described in U.S. Pat. No. 7,678,872. Erodible matrix materials include one or more cellulose derivatives, crystalline or noncrystalline forms that are either soluble or insoluble in water.

The time frame for release of an encapsulated ingredient via diffusion can be adjusted and tailored to the need by adjusting the crosslink density of the encapsulating coating. A polymer with little to no crosslinking exhibits a fast-dissolving coating for a short interval before release. Highly crosslinked materials can have a much slower rate of release of soluble ingredients in the coating. If mobility of the chemicals of interest is too low in a crosslinked membrane, dissolvable fillers like salts, organic crystalline solids, etc. can be incorporated in the coating mixture. Once the coated proppant is introduced downhole, the particles can dissolve to leave larger pores, as has been done with filtration membranes as in U.S. Pat. No. 4,177,228 entitled “Method of Production of a Micro-Porous Membrane for Filtration Plants.” If lightly crosslinked or a hydrogel, the polymer swells and will allow a controlled diffusion of the encapsulated additives.

Insoluble polymers, such as the thermosets (e.g., alkyds, partially-cured acrylics, phenolics, and epoxies) and the thermoplastics (e.g., polysulfones, polyethers, and polyurethanes) can be used as thin coatings with dissolvable additives. Such coatings are prepared by mixing, e.g., a thermoset polymer with finely divided, dissolvable solids and applying the resulting mixture to the proppant particles. Thermoplastics can be applied by dissolving the thermoplastic polymer in a solvent, mixing in the finely divided, dissolvable solids, and coating the proppants with the mixture. The solvent is then removed with a drying stage, which may be no more than a cross-flowing air stream. The time before release can be adjusted based on the size, shape, and solids concentration.

In some embodiments, the processes described herein provide for the formation of a self-polishing coating that dissolves over time or is eroded as fluid passes over the surface of the coating. Suitable materials for such coatings include acrylate copolymers with hydrolysable silylacrylate functional groups. (See U.S. Pat. No. 6,767,978.) Alkyds, which are polyesters, can also be used as they tend to hydrolyze over time under downhole conditions and thereby impart a delayed-release mechanism through combination of hydrolysis and erosion.

Cellulosic coatings can also provide a timed release coating. Suitable and include, but are not limited to, the hydroxyalkyl cellulose family such as hydroxyethyl methylcellulose and hydroxypropyl methylcellulose (also known as hypromellose). A suitable material is commercially available under the tradename METHOCEL from Dow Chemical. This material is a cellulose ether made from water-soluble methylcellulose and hydroxypropyl methylcellulose polymers. Rheological modification can also be provided from the use of a hydroxyethyl cellulose agent, such as those commercially available under the tradename CELLOSIZE, from Dow Chemical.

Polyamides, which can be hydrolyzed under downhole conditions, can be used as well.

Acid/Base-Resistant Coatings.

The light weigh proppants can also have acid/base-resistant coatings. Chemical attack of a proppant is a concern in hydraulic fracturing. For silica sand, the acid number of a proppant is often used to designate the sand's quality. The test in ISO 13503-2, section 8 describes the specific testing of proppant sand under acid exposure as a way to determine its suitability for specific well conditions. If components or impurities in the sand dissolve or are unstable in acidic environments, the proppant grains will gain porosity and exhibit a lower overall crush resistance. It can, therefore, be desirable to have a coating that could minimize the attack on the silica sand by acids found in downhole groundwaters.

Basic solutions can also dissolve or partially degrade silica proppants and the resin coating on such proppants, especially at a pH of nine or higher. This can cause issues in conductivities of proppant packs placed in fractures, due to weakening of the grains and possible reduction in particle size due to dissolving of outer layer of the particles.

Ceramic proppants can also suffer under highly basic or acidic waters as a result of diagenesis, a phenomenon in which the ceramic dissolves in aqueous solutions under pressure followed by a re-precipitation with other elements present in the fluid. The re-formed solid is unlikely to be as strong or the same size as the original ceramic proppant and can be a significant concern for its effects on conductivity of a ceramic proppant pack.

In some embodiments, the coatings that are applied are acid resistant, base resistant, or both, and can offer new protections for proppants of all types, including, but not limited to, sand and ceramic proppants. Some of the acid-resistant polymers that can be applied include: polypropylene, acrylic polymers, and most fluoropolymers. For increased coverage of the total exterior surface of the proppants, multiple coating applications of the same base polymer might be needed, depending on the equipment and number of dispersion nozzles that are used. The processes described herein can be repeated until the appropriate number of coatings are applied.

Suitable base-resistant polymers include the polyolefins, some fluoropolymers (except that PVDF and FKM are not particularly resistant to strong bases) and many polyurethanes.

Corrosion Inhibitors.

The light weight proppant can also have a corrosion inhibitor. Corrosion of metals in downhole applications is a significant problem in the oil and gas industry. Corrosion can occur via either an acid-induced process or via oxidation. Acidic conditions can be caused by acid treatment of the formation, acid or H₂S producing bacteria, or CO₂ that can dissolve in water under pressure to form carbonic acid. Oxidation/oxidative corrosion of the metal can occur in the presence of water and oxygen.

Corrosion in downhole applications is often addressed by addition of corrosion inhibitors and/or acid scavengers during drilling, completion, or hydraulic fracturing. The corrosion inhibitor provides a coating to passivate the metal surfaces exposed to the fluids. Passivating layers of small molecules are also applied via addition of these molecules in a treating fluid, followed by use of complexation chemistry to attach the molecules to the metal, e.g., the use of active ligand sites on small organic molecules or polymers to bind to the metal. Acid scavengers are acid-accepting and basic compounds. Periodic washing or flushing with fluids containing such materials after the initial treatment is also a common method to keep corrosion under control.

Oxygen scavengers are used to remove dissolved oxygen from downhole fluids. Once a well is completed, oxygen is not usually a significant problem as it is not normally present in producing formations, but it can be a problem in drilling muds and fracture fluids. Oxygen scavengers are used in these fluids during drilling, fracturing or completion.

Polymeric coatings for the metallic surfaces to prevent corrosion are often used, and applied to the metals prior to their use. Baked resins, or epoxy coatings, are two examples, but other polymers can be used on the metals. Cathodic protection is also used where possible, by placing a more reactive metal near the metal to be protected, and using the more reactive metal to react or oxidize with the chemistries in the fluid, rather than the metals which are desired to be protected. Zinc, aluminum and other metals which are more reactive than iron (Fe) are used for cathodic protection.

Chemicals that can be applied to the solids for corrosion protection include 1-benzylquinolinium chloride (CAS 15619-48-4), acetaldehyde (CAS 57-07-0), ammonium bisulfite (CAS 10192-30-0), benzylideneacetaldehyde (CAS 104-55-2), castor oil (CAS 8001-79-4), copper chloride anhydrous (CAS 7447-39-4), fatty acid esters (CAS 67701-32-0), formamide (CAS 75-12-7), octoxynol 9 (CAS 68412-54-4), potassium acetate (CAS 127-08-2), propargyl alcohol (CAS 107-19-7), propylene glycol butyl ether (CAS 15821-83-7), pyridinium, 1-(phenylmethyl)-(CAS 68909-18-2), tall oil fatty acids (CAS 61790-12-3), tar bases, quinoline derivatives, benzyl chloride-quaternized (CAS 72480-70-7), and triethylphosphate (CAS 78-40-0), or any combination thereof.

Corrosion inhibitors that are solids can be mixed into resin formulations as a filler, then applied to proppants to form a coating that can deliver the corrosion protection directly downhole. The coatings can be designed to deliver corrosion protection immediately, as might be desired for oxygen scavengers during drilling or completion. The coatings can also be tailored for timed release of corrosion, as discussed above. Cathodic protection can be provided by also including one or more metal particles (Zn, Al, and the like) in highly conductive produced waters/brines.

Corrosion inhibitors that are liquids can be introduced into these systems via selection of a polymer proppant coating in which the liquids/organic chemicals are miscible or semi-soluble. Some examples include digycolamines mixed with polyacrylamides, or lightly crosslinked or thermoplastic polyurethanes.

Other polymers, such as 2-vinyl-2-oxyzoline can be used as water soluble polymer fillers that can be encapsulated in a resin coating on proppant particles, and dissolved over time from the coating. The soluble molecules can then passivate metal surfaces, and inhibit acidic corrosion.

Acid scavenging activity can be provided with a flash coating of polymers having acid scavenging attributes. For example, polymers with nitrogen containing heteroatoms such as polyvinylpyridine and polyvinylpyrrolidone, carboxylates, or pendant amines can provide such acid scavenging activity, i.e., nitrogen can interact with acids to form a salt. The scavenging power of these polymers can be related to the concentration of functional groups on the polymer as well as the mobility and accessibility of these groups to react with the produced fluids and remove acidic impurities.

Paraffin Inhibitors.

Light weight proppants can also have paraffin inhibitors. Paraffins are long chain hydrocarbons, typically C₁₈ to C₁₀₀ or more (18-100 carbons) that often precipitate out of a hydrocarbon solution due to changes in temperature or composition that decrease the solubility of the paraffin in the hydrocarbon fluids. Once precipitated, those paraffins can crystallize to form a waxy buildup.

In some embodiments, paraffin inhibitors can be coated into or onto proppants. Such a coating places the treatment in the fractured strata and at the elevated temperatures found downhole before the paraffins have begun to precipitate or crystallize. By introducing the inhibitors in the fractured strata while the paraffins are still soluble, the treatment can affect the crystallization rate of paraffin as the produced hydrocarbon stream cools and/or mixes with water as it moves towards the surface and consolidates with other fracture streams for recovery. Such conditions often result in reduced paraffin solubility and create conditions where paraffin precipitation and crystallization become problematic.

The paraffin inhibitors of the present disclosure can be added as a polymeric coating on the proppants or as released additives. The coated polymers can stay associated with the proppant particles until the proppant was exposed to hydrocarbons whereupon the polymers can dissolve in the hydrocarbon or mixed hydrocarbon/water effluent. Releasable additives contained in timed release or staged release coatings of the types discussed above allow the paraffin inhibitor additives to be released over time via diffusion out of the swelled or dissolving coating or by migration out of a coating whose soluble particulates had left openings for egress of the paraffin additives.

Polymers that can serve as paraffin inhibitors include, e.g., styrene ester copolymers and terpolymers, esters, novalacs, polyalkylated phenol, and fumerate-vinyl acetate copolymers. Tailoring the molecular weight of the inhibitor as well as the lengths of the pendant chains can be used to modify the nature of the inhibition effects. These characteristics affect both the crystallization rate and size distribution of paraffin crystals and thus the pour point of the resulting solutions.

Paraffin pour point can be decreased by adding solvents to a hydrocarbon mixture to increase solubility of paraffin, and thus reduce the crystallization rate and overall crystallite size distribution of the paraffin crystals. These are often copolymers of acrylic esters with allyl ethers, urea and its derivatives, ethylene-vinlyacetate backbone with unsaturated dicarboxylic acid imides, dicarboxylic acid amides, and dicarboxylic acid half amides.

Polymers that are useful for paraffin crystal modification include ethylene-vinyl acetate copolymers, acrylate polymers/copolymers, and maleic anhydride copolymers and esters.

Paraffin dispersants work via changing the paraffin crystal surface, causing repulsion of the paraffin particles and thus inhibit formation of larger paraffin agglomerates that could precipitate from suspension in the reservoir fluids. Typical chemistries include olefin sulphonates, polyalkoxylates and amine ethoxylates.

Asphaltene Inhibitors.

In some embodiments, asphaltene inhibitors can be coated into or onto proppants. Asphaltenes are complex polycyclic aromatic compounds, often with heteroatoms and with aliphatic side chains. They are present in many hydrocarbon reserves at concentrations that vary from <1 to 20%. They are soluble in benzene or aromatic solvents but insoluble in in low molecular weight alkanes.

Asphaltenes pose similar issues to the paraffins in that they are typically soluble in the pressurized, heated hydrocarbon mixture in a reservoir field, but changes in temperature and pressure during production from that reservoir can cause precipitation or flocculation. Either of these can have the effect of reducing fluid flow or, in the worst case, stopping fluid flow completely. Once the asphaltenes precipitate, the well must be remediated by mechanically scraping or dislodging the deposits through the application of differential pressures or by cleaning with toluene, xylene, or other suitable aromatic solvent. Cleaning is expensive and stops well production during the process so the asphaltene additives carried by treated proppants represent a substantial economic benefit for well owners and operators.

Asphaltene is controlled via use of dispersing additives or inhibitors. Dispersants reduce the particle size of the precipitated asphaltenes and keep them in suspension. Dispersants are often used as fracture fluid additives at a point after asphaltene precipitation is likely to occur, i.e., after a pressure drop or temperature drop as the oil moves from the reservoir into the production channels. Dispersants are usually nonpolymeric surfactants. Some asphaltene dispersants that have been used in fracture fluids include: very low polarity alkylaromatics; alklarylsulfonic acids; phosphoric esters and phosphonocarboxylic acids; sarcosinates; amphoteric surfactants; ethercarboxlic acids; aminoalkylene carboxylic acids; alkylphenols and their ethoxylates; imidazolines and alkylamine imidazolines; alkylsuccinimides; alkylpyrrolidones; fatty acid amides and their ethoxylates; fatty esters of polyhydric alcohols; ion-pair salts of imines and organic acids; and ionic liquids.

Inhibitors actually prevent the aggregation of asphaltene molecules and prevent precipitation. Asphaltene inhibitors are typically polymers. Common asphaltene inhibitors that have typically been used in fracture fluids include: alkylphenol/aldehyde resins and sulfonated variants of these resins; polyolefin esters, amides, or imides with alkyl, alkylene phenyl, or alkylene pyridyl functional groups; alkenyl/vinylpyrolidone copolymers; graft polymers of polyolefins with maleic anhydride or vinylimidazole; hyperbranched polyesterimides; lignosulfonates; and polyalkoxylated asphaltenes.

Polymeric asphaltene inhibitors can be introduced directly as coatings on the proppant particles. They can be applied as coatings that can be released in a controlled fashion either immediately or slowly over time by the timed release and staged release coatings discussed above.

The asphaltene inhibitors can also be used as an additive in a polymeric coating.

Asphaltene dispersants can be used mainly as ingredients/fillers in a coating to be released over time. Their release over time can be controlled with the coatings discussed herein depending on whether an immediate release or timed release dosing is desired. Branched polymers with arms that contain the dispersant functionality can also be used where the branches are connected to the polymer backbone by reactive groups that might degrade over time, such as esters, hydrolysable groups, and the like to release the dispersants over time.

An advantage of using asphaltene control agents directly on proppant particles is that these agents can be released within the formation prior to asphaltene precipitation. Such an in-situ delivery allows effective treatment before development of the problem and in controlled concentrations.

The light weight proppants described herein can be used in a gas or oil well. For example, the proppants can be used in a fractured subterranean stratum to prop open the fractures as well as use the properties of the proppant in the process of producing the oil and/or gas from the well. In some embodiments, the proppants are contacted with the fractured subterranean stratum. The proppants can be contacted with the fractured subterranean stratum using any traditional methods for introducing proppants and/or sand into a gas/oil well. In some embodiments, a method of introducing a proppant into a gas and/or oil well is provided. In some embodiments, the method comprises placing (e.g. injecting) the proppants into the well. In some embodiments, the well is a well that has already been fractured. Therefore, in some embodiments, methods of refracking a well are provided. In some embodiments, the method comprises contacting (injecting) coated particulates (e.g., proppants) into a well that has been previously fractured and has coated particulates (proppants) are in the fractured subterranean stratum. In some embodiments, the coated particulates that are injected are the particulates described herein comprising a coating comprising the compatibilizing agent and the hydrophobic polymer. In some embodiments, the method comprises contacting a fractured subterranean stratum comprising proppants with a coated particulate, wherein the coated particulate comprises a particulate core with a compatibilizing agent and a hydrophobic polymer coating the particulate core, wherein a portion of the hydrophobic polymer is exposed to provide an exposed hydrophobic surface of the coated particulate. In some embodiments, the method comprises extracting oil and/or gas from the refractured subterranean stratum. The methods for extracting the oil and/or gas can be any method suitable to extract such oil and gas.

In some embodiments, the proppants are injected with a gas or a gas is injected after the proppants are contacted with the fractured subterranean stratum that may or may not have proppants. In some embodiments, the gas is a mixture of gases. In some embodiments, the gas or mixture of gasses is a nonpolar gas or a mixture of nonpolar gases. In some embodiments, the gas or mixture of gases is nitrogen, air, carbon dioxide, or a combination thereof. In some embodiments, the gas results in bubble formation on the hydrophobic surface of the proppant. The bubble formation can enhance the transport of the coated particulates in the subterranean stratum.

The following examples are not to be limiting and are only some of the embodiments encompassed by the presently disclosed subject matter.

### Examples

### Example 1

A previously fractured well has a proppant coated with a compatibilizing agent and a hydrophobic polymer as described herein injected into the previously fractured well. The well is re-stimulated and the extraction of oil and gas out of the well is enhanced. It is surprising that the well is re-stimulated with the use of light weight proppants.

This description is not limited to the particular processes, compositions, or methodologies described, as these may vary. The terminology used in the description is for the purpose of describing the particular versions or embodiments only, and it is not intended to limit the scope of the embodiments described herein. Unless defined otherwise, all technical and scientific terms used herein have the same meanings as commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

It must also be noted that as used herein and in the appended claims, the singular forms “a”, “an”, and “the” include plural reference unless the context clearly dictates otherwise.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Various references and patents are disclosed herein, each of which are hereby incorporated by reference for the purpose that they are cited.

From the foregoing, it will be appreciated that various embodiments of the present disclosure have been described herein for purposes of illustration, and that various modifications can be made without departing from the scope and spirit of the present disclosure. Accordingly, the various embodiments disclosed herein are not intended to be limiting.

1. A method of extracting oil and/or gas from a previously fractured subterranean stratum comprising proppants, the method comprising:
injecting a light weight proppant into the previously fractured subterranean stratum; and
extracting the oil and/or gas from the previously fractured subterranean stratum.

2. The method of claim 1, wherein the light weight proppant is injected with slickwater.

3. The method of claim 1, wherein the light weight proppant is a coated particulate comprising a particulate core with a compatibilizing agent and a hydrophobic polymer coating the particulate core, wherein a portion of the hydrophobic polymer is exposed to provide an exposed hydrophobic surface of the coated particulate.

4. The method of claim 3, wherein the compatibilizing agent binds the hydrophobic polymer to the particulate.

5. The method of claim 3, wherein the compatibilizing agent encapsulates the particulate core and a first surface of the hydrophobic polymer binds to the compatibilizing agent and a second surface of the hydrophobic polymer is exposed to provide the exposed hydrophobic surface of the coated particulate.

6. The method of claim 3, wherein the coated particulate has enhanced particulate transport as compared to a particulate without the exposed hydrophobic surface.

7. The method of claim 3, wherein the compatibilizing agent is a alkoxysilane.

8. The method of claim 7, wherein the alkoxysilane is a methoxysilane, ethoxysilane, butoxysilane, or octoxysilane.

9. The method of claim 3, wherein the compatibilizing agent is a surfactant.

10. The method of claim 9, wherein the surfactant is a hydroxysultaine.

11. The method of claim 10, wherein the hydroxysultaine is cocamidopropyl hydroxysultaine.

12. The method of claim 3, wherein the compatibilizing agent is an alkoxylated alcohol.

13. The method of claim 3, wherein the compatibilizing agent is an acrylate polymer.

14. The method of claim 3, wherein the hydrophobic polymer is an amorphous polyalphaolefin.

15. The method of claim 1, wherein the hydrophobic polymer is a non-siloxane hydrophobic polymer.

16. (canceled)

17. The method of claim 1, wherein the light weight proppant is substantially free of a hydrogel.

18-25. (canceled)

26. The method of claim 1, wherein the light weight proppant is substantially free of a frother.

27. The method of claim 1, wherein the light weight proppant has a sand particle core.

28-30. (canceled)

31. The method of claim 1, wherein the method increases the fracture height and half-length and/or creates uniform vertical and horizontal proppant distribution as compared to the previously fractured subterranean stratum.

32. The method of claim 1, wherein the light weight proppants are injected or treated with a gas.

33-37. (canceled)
